(19) United States
(12) Patent Application Publication
(10) Pub. No.: US 2011/0018334 A1
(43) Pub. Date: Jan. 27, 2011

(54) WHEEL AND RIM LIP COMBINATION

(76) Inventor: Ken Ruff, Ft. Lauderdale, FL (US)

Correspondence Address: Joseph J. Zito, 1250 Connecticut venue, NW, Suite 200, Washington, DC, 20036, US

(21) Appl. No.: 12/715,325

(22) Filed: Mar. 1, 2010

Related U.S. Application Data
(60) Provisional application No. 61/156,652, filed on Mar. 2, 2009.

(51) Int. Cl. B60B 7/01; B60B 1/06; B60B 3/00

(52) U.S. Cl. 301/37.24

(57) ABSTRACT

A wheel and trim assembly having a central wheel portion, a outer rim and a plurality of spokes connecting said central portion with said outer rim. The wheel may be spokeless or may be designed as a solid wheel. The wheel assembly also includes one or more removable, replaceable, interchangeable lip trim pieces configured for attachment to the outer rim of the wheel in a close matching relation to the outer rim so as to provide decorative trim which doe snot easily separate from the wheel. The trim rings can optionally be permanently attached to said wheel, in which event they are reselectable, not interchangeable.

### CROSS REFERENCE TO RELATED APPLICATIONS

This application claims the benefit of provisional patent application 61/156,652, filed Mar. 2, 2009.

### BACKGROUND OF THE INVENTION

The present invention is a wheel with a rim lip trim piece. The trim ring piece adds color, decoration and/or alternative finish to the wheel.

Basic automobile, SUV and light truck wheels are typically made of steel. Hubcaps, wheel covers or other wheel trims can be used to enhance the appearance of plain steel wheels. Wheel covers typically extend from the center of the wheel to the rim, hubcaps cover only a central portion of the wheel and trim rings typically cover only the outer portion of the wheel adjacent the tires. Cars with stamped steel wheels often use a full wheel cover that conceals the entire wheel. Alloy or stylized steel wheels typically do not have any trim. Alloy wheels themselves are decorative as well as functional and the lack of trim avoids the problems of separation from the wheel which can occur with any type of trim, including trim rings, wheel covers and hubcaps.

Early hubcaps were very small, sometimes merely covering the greased wheel bearing at the center of the wheel. These hubcaps snap onto bulges on the wheel, and were pried off with a tool to access the wheel bearing. Spinners were used with wire wheels to retain the wheel on the axle and cover the wheel bearings. When pressed steel wheels became common, they were often painted the same color as the car body. Hubcaps expanded in size to cover the lug nuts that are used to mount steel wheels. Chrome-plated trim rings that clipped onto the outer rim of a wheel were introduced as trim in addition to a center hubcap. Later full wheel covers, made of plastic, which cover the entire wheel are more commonly used as trim on plain steel wheels. Wheel covers often imitate the look of alloy wheels typically made of magnesium or aluminum alloy. Alloy wheels generally use small removable center caps, similar in size to the earliest hubcaps, leaving the remainder of the wheel undecorated.

One difficulty with wheel covers, trim rings and full hubcaps is a tendency to separate from the wheel under certain conditions, including bumps and potholes. Center caps don't fall off as often, but they leave portions of the wheel undecorated. Rim trim rings, which can be combined with center caps will add decoration to the wheel but suffer from the same separation problems as wheel covers and full hub caps, often being attached in the same clip on manner. One solution has been to permanently integrate a trim ring into the alloy wheel, while this reduces the likelihood of separation, it prevents interchangeability of wheel trim.

The problem of loss of removable trim rings persists today in spite of the many different retention systems that have been engineered. Full hubcaps and trim rings generally use clip-on retention, where some type of spring steel or plastic clip engages a groove in the wheel. Clip-on and other prior art trim rings are typically loose around the edges and can be susceptible to vibration.

### SUMMARY OF THE INVENTION

The present invention includes a wheel having a central portion, a outer rim and a plurality of spokes connecting said central portion with said outer rim. In other embodiments, the wheel may be spokeless or may designed as a solid wheel. The wheel has an outer facing surface and an inner facing surface. The wheel also includes one or more removable, replaceable, interchangeable lip trim pieces configured for attachment to the wheel in a close matching relation to the outer rim portion. The lips can optionally be semi-permanently or permanently attached to said wheel, in which event they are selectable and interchangeable, however they may not be reusable.

The lip trim piece of the present invention can be removably or permanently attached to the wheel. The trim ring is mountable from the back side of the wheel, thus concealing the attachment pieces, rendering the trim integral to the wheel or alternatively may be attached from the exposed side of the wheel thus rendering the attachment pieces part of the wheel styling. Because the trim ring may be removable, it allows for customization not available with permanently affixed trim. The end user can customize the look of the wheel at time of purchase and can later change that customization if desired. Customizable trim also reduces inventory by requiring fewer wheels to be stocked while maintaining customer selection options by stocking a plurality of trim ring options. Customizable trim rings also allow resale or reuse of the wheel on different vehicles by changes in trim, thus increasing trim sale while maintaining wheel resale value.

The outer rim portion of the wheel may include a recessed annular section for receipt of a portion of the lip piece and may also include a tongue and groove to reduce vibration. The lip piece may be co-terminus with said rim portion about its outer circumference or, alternatively may have an outer circumference of reduced diameter.

In one embodiment, the interior facing surface of said wheel includes a plurality of sites for accommodation of releasable fasteners for releasable connection of one or more interchangeable lips to the rim of a wheel. The lips having corresponding sites to accommodate the releasable fasteners. A plurality of fasteners are utilized to secure a lip to a wheel rim. The fastening sites can be holes in a flange portion of the wheel which accommodates a threaded fastener such as screw which are aligned with threaded holes in a portion of the removable lip which radially overlaps the flange.

The removable lips can also have radial cutouts to accommodate the spokes of a wheel or to accommodate other wheel contours or profiles. The removable lip can be advantageously constructed of heat resistant, printable plastic so that a plurality of colors and/or patterns can be provided. The wheel and spokes are constructed of appropriate materials for the application of the wheel and the accommodation of the removable lip allows for the addition and for the change of trim ring without affecting the structural integrity of the wheel regardless of the materials used for the lip.

The wheel with removable lip trim of the present invention can be adapted to any size or style of spoked or solid wheel. In some applications, break caliper clearance may need to be accommodated.

### BRIEF DESCRIPTION OF THE DRAWINGS

For a better understanding of the nature of the present invention, reference is had to the following figures and detailed description, wherein like elements are accorded like reference numerals, and wherein:

FIG. 1 is an assembly view of the present invention illustrating the major components of the invention.

FIG. 2 is an outside view of the assembled wheel and lip of the present invention.

FIG. 3 is an inside cutaway perspective view illustrating the lip and wheel assembly.

FIG. 4 is a side cutaway detail view illustrating the attachment configuration of a first embodiment of the present invention.

FIG. 5 is an inside cutaway view of the attachment mechanism of FIG. 4.

FIG. 6 is a side cutaway detail view illustrating a straight lip embodiment of the present invention.

FIG. 7 is an assembly view of an embedment of the present invention.

FIG. 8 is an inside assembly view of an embodiment of the present invention.

FIG. 9 is an inside view of the assembled wheel and lip of an embodiment of the present invention.

FIG. 10 is a perspective cutaway view of an alternative fastening mechanism of an embodiment of the present invention.

FIG. 11 is an assembly view of the embodiment of FIG. 10.

FIG. 12 is a second assembly view of the embodiment of FIG. 10.

FIG. 13 illustrates the fully assembled lip and wheel of the embodiment of FIG. 10.

### DETAILED DESCRIPTION OF PREFERRED EXEMPLARY EMBODIMENTS

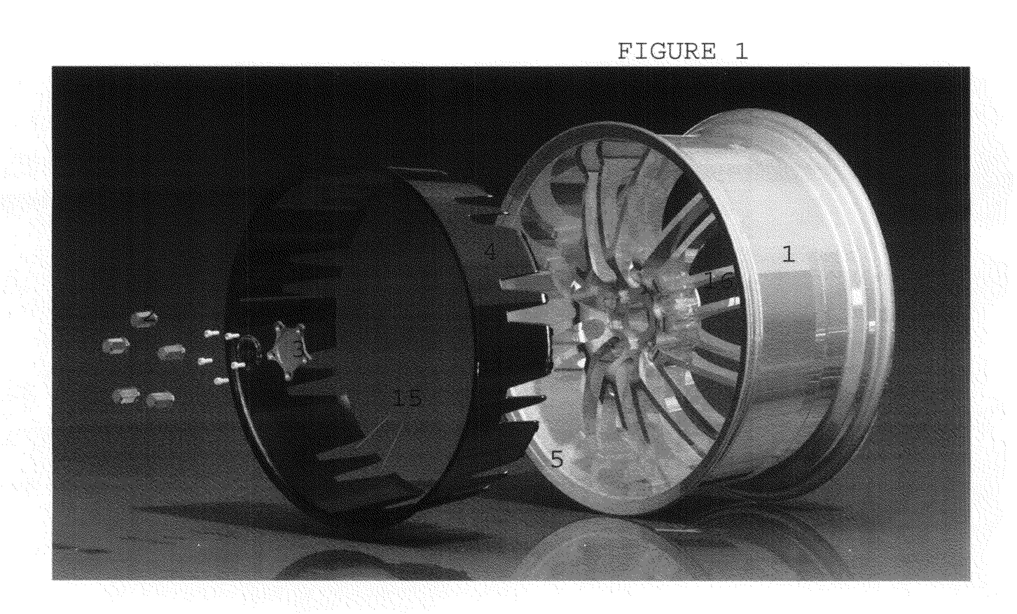

FIG. 1 illustrates an alloy wheel 1, mounting lug nuts 2 and a decorative center cap 3. Also illustrated is a trim ring piece 4 which enhances the appearance of the outer rim of the wheel 1.

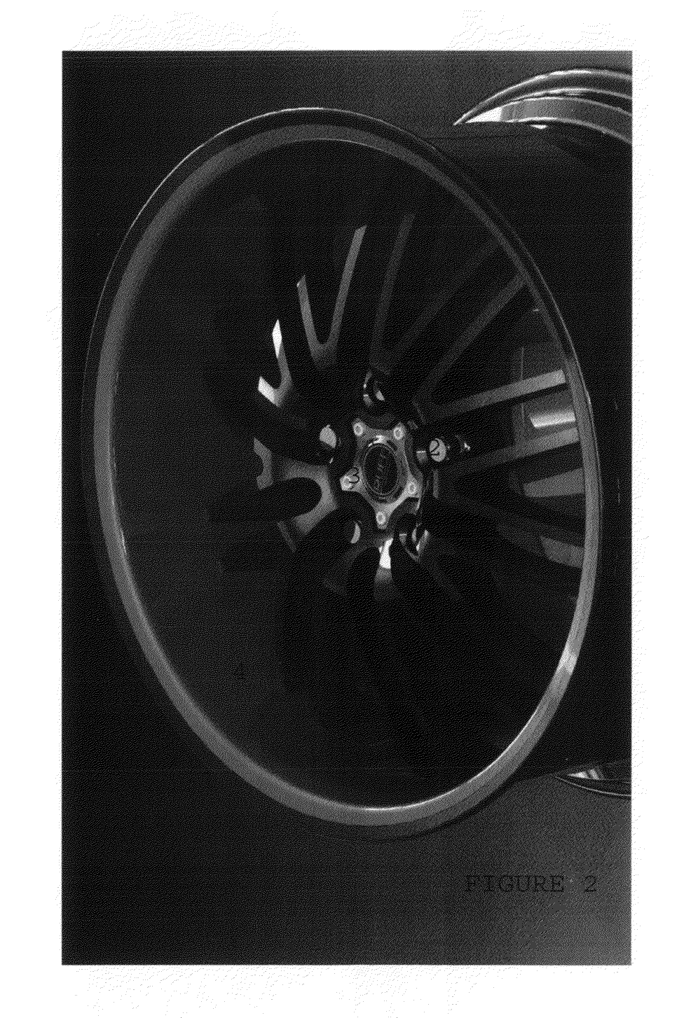

FIG. 2 illustrates the lug nuts 2, center cap 3 and trim ring piece 4 assembled to the wheel 1. Trim ring 4 is seated in recess 5 along the rim of wheel 1.

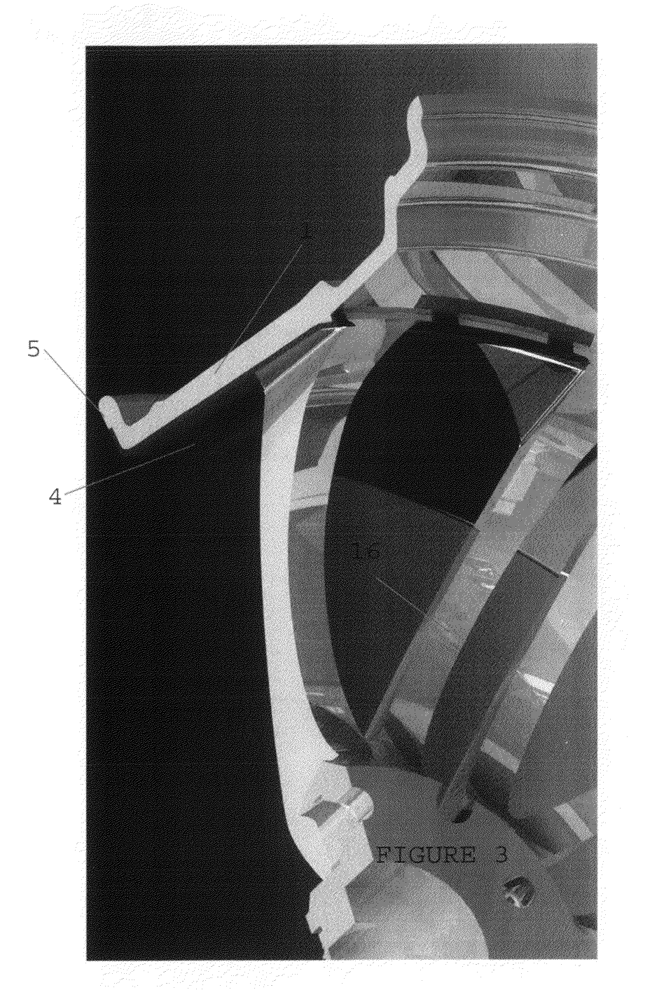

FIG. 3 is a detailed cutaway view illustrating the seating of trim ring 4 in the recess 5 of wheel 1. Trim ring 4 is flush with the outer surface of wheel 1.

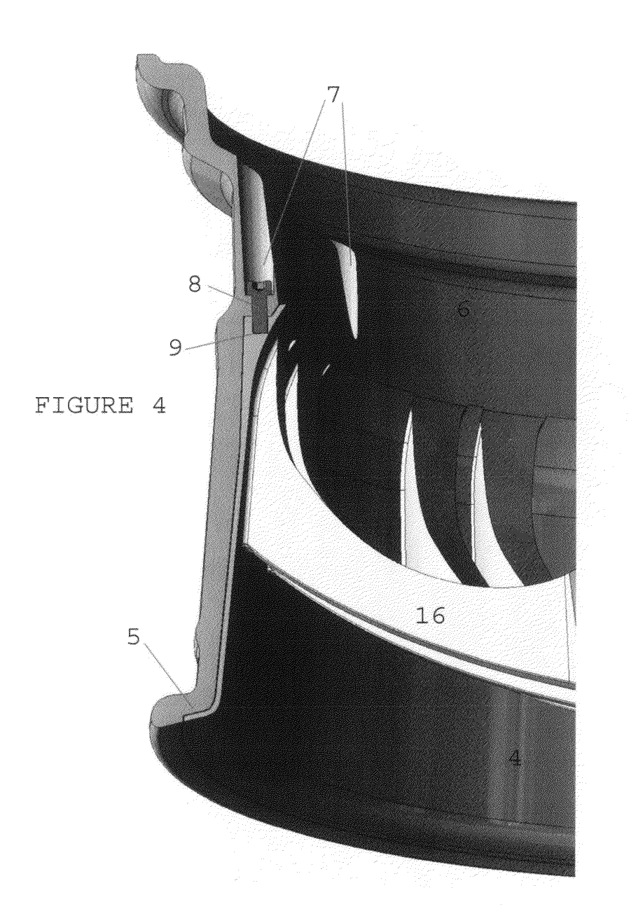

FIG. 4 illustrates a first configuration for securing the trim ring 4 to the wheel 1. The interior face 6 of wheel 1 is provided with a plurality of holes 7 which accommodate fasteners 8, which can be threaded. Fasteners 8 pass through the holes 7 in the back side of the wheel 1 and into openings 9 in the trim ring 4 which are adapted to securely receive fasteners 8. The fasteners 8 and openings 9 maybe complementarity threaded to provide secure attachment alternatively, the fasteners 8 may be secured into the openings 9 by adhesion, epoxy, glue or the like.

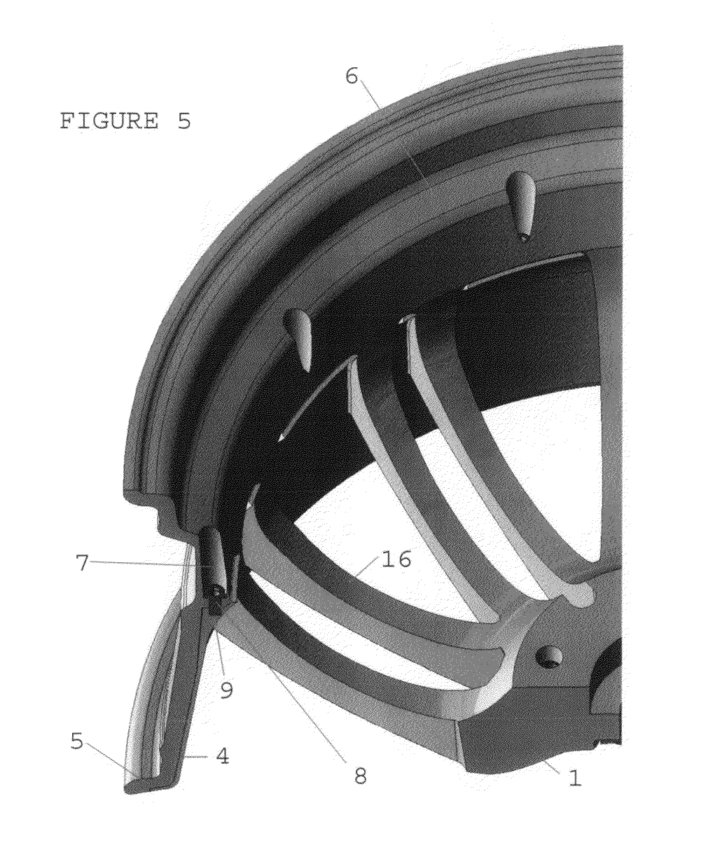

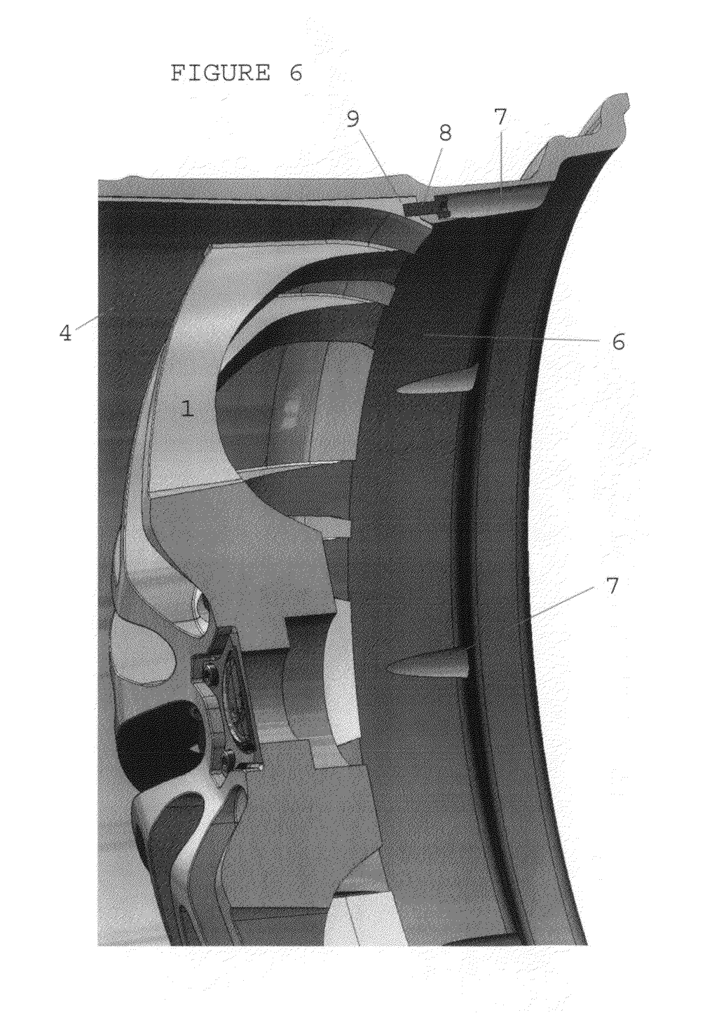

The attachment is illustrated from the inside of the wheel 1 in FIG. 5. The fasteners 8 pass through holes 7 in the inside of wheel 1 and are secured into openings 9 in the trim ring 4 which has a lip seated in a recess 5 in the rim of the wheel 1. The attachment is further illustrated in FIG. 6 from a separate perspective.

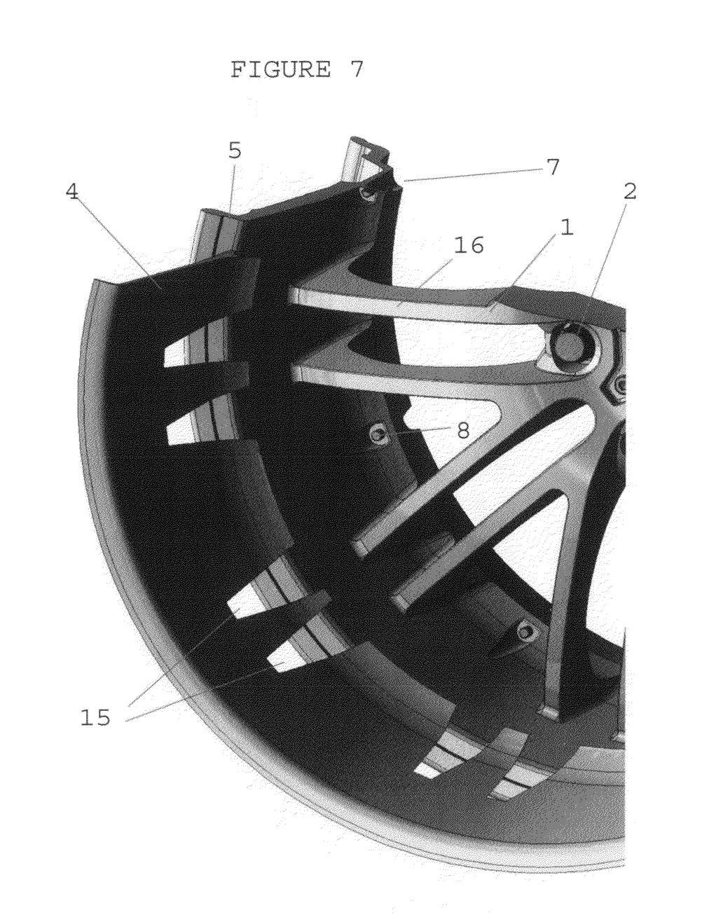

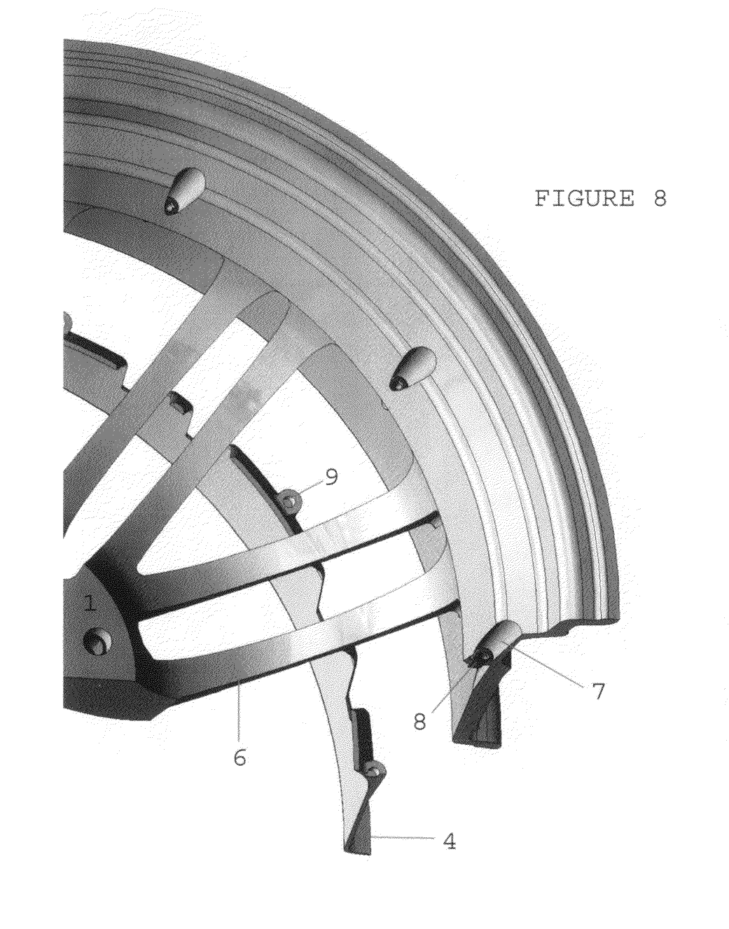

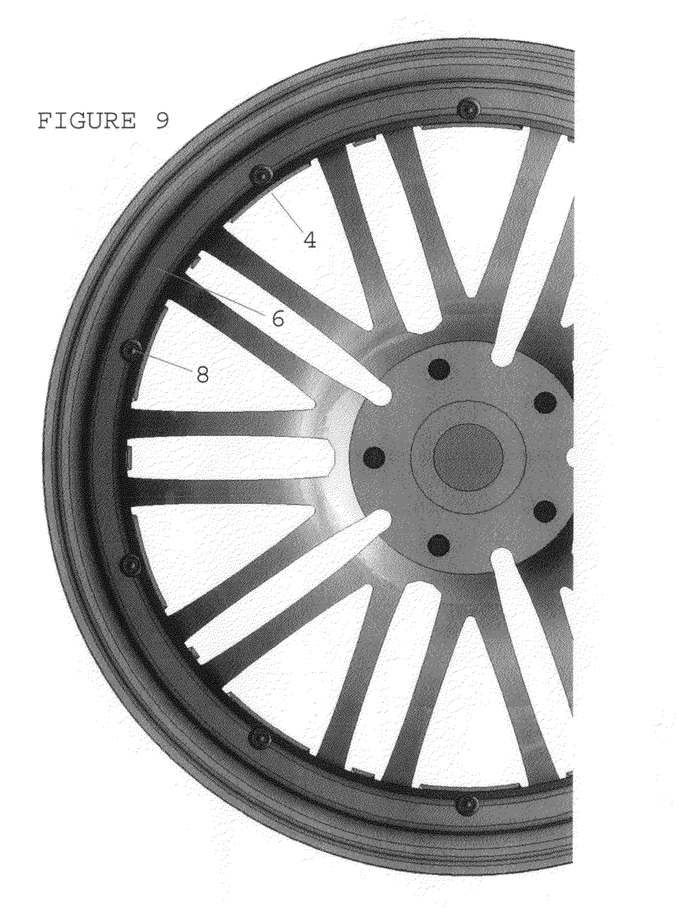

Prior to assembly, or during removal for exchange or replacement, as illustrated in FIG. 7, the fasteners 8 may extend through holes 7. Assembly/disassembly is also illustrated in FIG. 8 from the back side of the wheel 1. Looking from the interior of the wheel 1, in FIG. 9, trim ring 4 is visible overlapping the wheel 1.

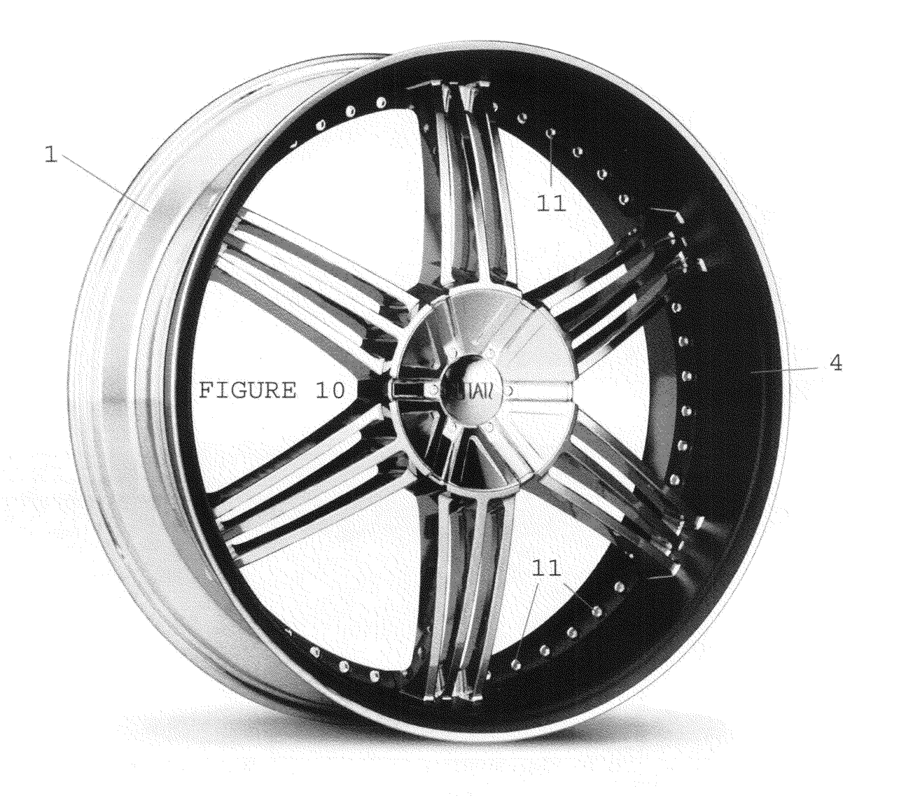

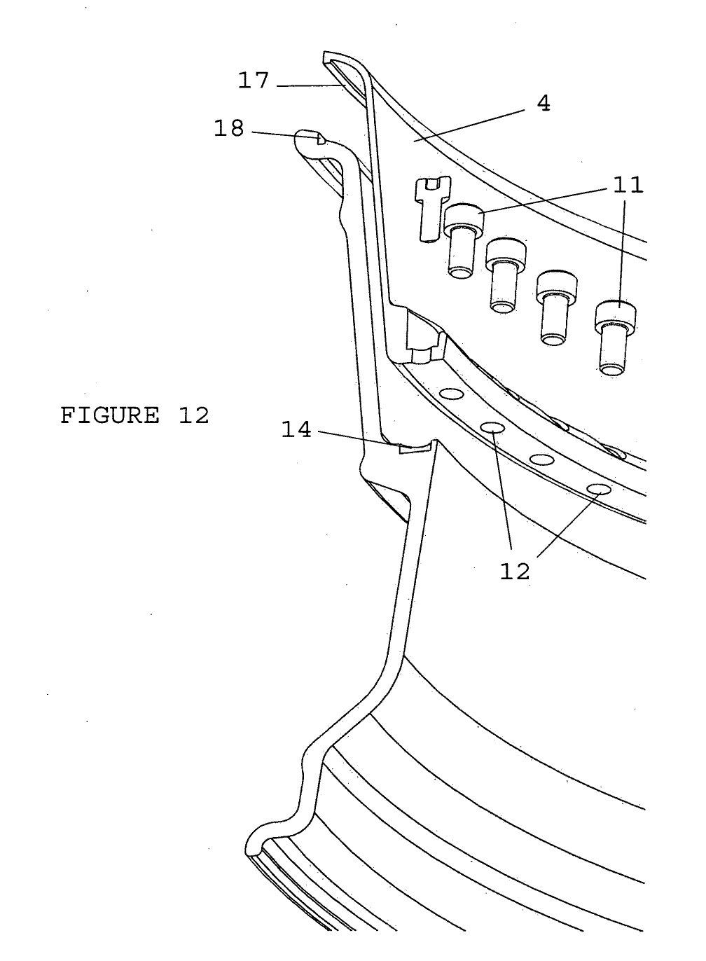

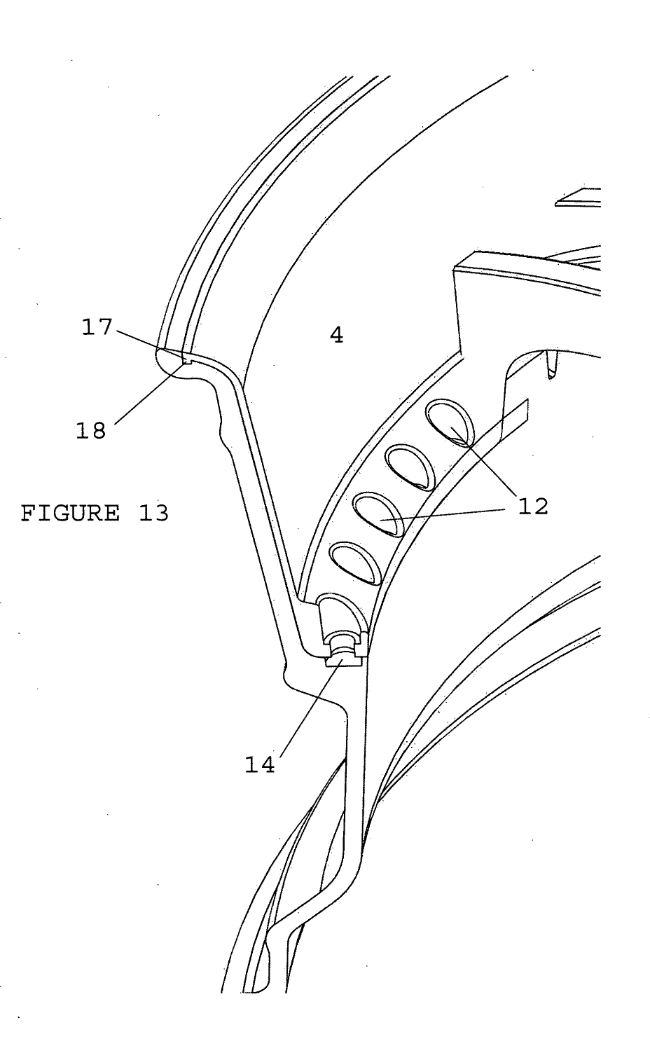

FIG. 10 through 13 illustrates an alternative embodiment wherein fasteners 11 are inserted through holes 12 in trim ring 4 and into opening receptacles 14 in wheel 1. Fasteners 11 are inserted from and exposed to the outer or exterior face of wheel 1. Thus the fasteners remain visible and become a part of the trim enhancement to the appearance of the wheel 1. As above, the fasteners are inserted through holes 12 and secured in openings 14. Fasteners 11 may be threaded, epoxied, adhered, glued or otherwise retained in position to secure trim 4 to wheel 1.

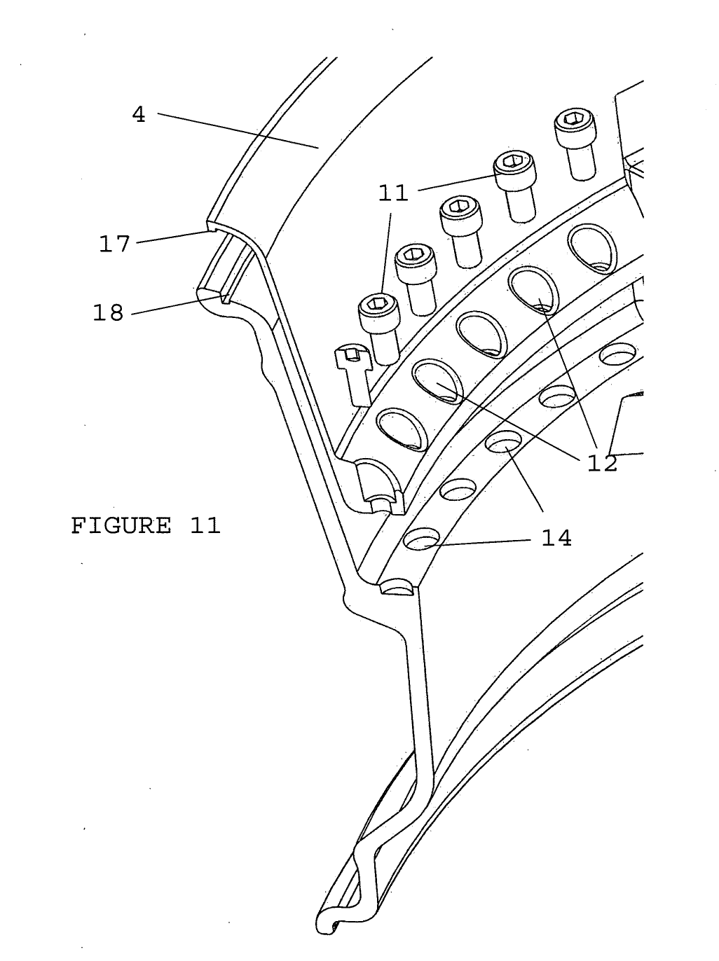

The trim ring 4 and rim may also include a tongue 17 and groove 18, as illustrated in FIGS. 11, 12 and 13, for alignment and to maintain the trim ring 4 in position along the rim of the wheel 1.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

I claim:

1. A wheel, having an outer facing surface and an inner facing surface, comprising:
a central portion;
a outer rim;
a plurality of spokes connecting said central portion with said outer rim; and
a trim ring configured for attachment to said wheel adjacent said outer rim of said wheel and having openings to accommodate said spokes.

2. The wheel of claim 1, wherein said trim ring is removably attached to said wheel.

3. The wheel of claim 1, wherein said trim ring is non-removably attached to said wheel.

4. The wheel of claim 1, further including fasteners for removably affixing said trim ring to said wheel, wherein said fasteners extend through openings in said wheel and are secured within receptacles in said trim ring.

5. The wheel of claim 4, wherein said fasteners are exposed on said interior face of said wheel and concealed on said exterior face.

6. The wheel of claim 1, further including fasteners for removably affixing said trim ring to said wheel, wherein said fasteners extend through openings in said trim ring and are secured within receptacles in said wheel.

7. The wheel of claim 6, wherein said fasteners are exposed on said exterior face of said wheel and concealed on said interior face.

8. The wheel of claim 1, wherein said outer rim of said wheel includes a recessed annular section for receipt of a portion of said trim ring.
In other embodiments, the wheel may be spokeless or may designed as a solid wheel.

9. The wheel of claim 1, wherein said trim ring comprises heat resistant, printable plastic.

10. A wheel and trim assembly, comprising:
a wheel having a center hub configured for mounting to a central axle, an inner face, an outer face, an outer rim configured for mounting of a tire, and a plurality of spokes extending from said center hub to said rim,
a trim ring having a first circumferential edge for positioning adjacent an outer edge of said rim and extending from said outer edge, past said spokes, towards an inner edge of said rim.

11. The wheel assembly of claim 10, further comprising:
a recessed annular portion in said outer edge of said rim, wherein said first circumferential edge of said trim ring is configured to seat in said recessed annular portion of said outer edge of said wheel rim.

12. The wheel assembly of claim 10, further comprising:
an annular flange extending from said rim toward said wheel center hub and having a plurality of holes;
a plurality of receptacles formed in said trim ring corresponding to said plurality of holes;
a plurality of fasteners configured to extend through said holes in said flange and to engage in said receptacles in said trim ring, securing said trim ring to said wheel.

14. The wheel assembly of claim 10, further comprising:
a plurality of holes formed in said trim ring;
an annular ledge protruding radially inward from said rim and having a plurality of receptacles formed in said ledge, corresponding to said plurality of holes;
a plurality of fasteners configured to extend through said holes in said trim ring and to engage in said receptacles in said ledge of said wheel, securing said trim ring to said wheel.

15. The wheel assembly of claim 11, further comprising:
an annular tongue formed in said trim ring; and
a corresponding annular groove, for engagement with said annular tongue, formed in said edge of said rim of said wheel.

16. The wheel of claim 4, wherein:
said fasteners are affixed within said receptacles in said trim ring by one of the group consisting of threads, adhesion, epoxy or glue.

17. The wheel assembly of claim 14, wherein:
said fasteners are affixed within said receptacles in said annular ledge by one of the group consisting of threads, adhesion, epoxy or glue.

18. A wheel and trim assembly, comprising:
a wheel having a center hub configured for mounting to a central axle, an inner face, an outer face, an outer rim configured for mounting of a tire, and an intermediate portion extending from said center hub to said rim and joined to said hub and said rim;
a trim ring having a first circumferential edge for positioning adjacent an outer edge of said rim and extending from said outer edge, along said rim to said joint of said rim and said intermediate portion;
a recessed annular portion in said outer edge of said rim, wherein said first circumferential edge of said trim ring is configured to seat in said recessed annular portion of said outer edge of said wheel rim;
an annular tongue formed in said trim ring;
a corresponding annular groove, for engagement with said annular tongue, formed in said edge of said rim of said wheel;
a plurality of holes formed in said intermediate portion of said wheel;
a plurality of receptacles formed in said trim ring corresponding to said plurality of holes;
a plurality of fasteners configured to extend through said holes in said flange and to engage in said receptacles in said trim ring, said fasteners are affixed within said receptacles in said trim ring by one of the group consisting of threads, adhesion, epoxy or glue, securing said trim ring to said wheel.

19. The wheel assembly of claim 18, wherein said intermediate wheel portion is a solid disk.

20. The wheel assembly of claim 18, wherein said intermediate wheel portion a plurality of spokes.
